(19) United States
(12) Patent Application Publication
(10) Pub. No.: US 2017/0334693 A1
(43) Pub. Date: Nov. 23, 2017

(54) METHOD AND APPARATUS FOR CRANELESSLY DELIVERING A FIBERGLASS SWIMMING POOL BODY

(71) Applicant: Thursday Pools, Fortville, IN (US)

(72) Inventors: William KHAMIS, Fortville, IN (US); Edward Vondell, Fishers, IN (US)

(73) Assignee: Thursday Pools

(21) Appl. No.: 14/674,668

(22) Filed: Mar. 31, 2015

(51) Int. Cl. B66F 3/46; B65G 67/24

(52) U.S. Cl. CPC B66F 3/46; B65G 67/24

(57) ABSTRACT

A kit for raising and lowering a fiberglass swimming pool body, including at least three elongated structural members, wherein each elongated member includes a pully operationally connected thereto, at least three base portions, at least three couplers, each respective coupler connectible to a respective base portion for receiving a respective elongated member, and at least three winches, each winch connectible to a respective coupler, wherein each winch includes a length of cable ending in a grapple operationally connected thereto.

### TECHNICAL FIELD

The present novel technology relates generally to the field of mechanical engineering, and, more particularly, to a method and apparatus for unloading a delivered fiberglass pool body from a flatbed truck without the necessity of a crane.

### BACKGROUND

Preformed fiberglass swimming pools offer many advantages over in-situ formed shotcrete or concrete walled swimming pools. Fiberglass pool bodies may be quickly and inexpensively formed and require considerably less effort to put into the ground. However, fiberglass pool bodies must be delivered from the point of manufacture to the desired swimming pool location, usually a residence and usually via flatbed truck. This means that the pool body recipient has to have a crane, large back hoe or track hoe, of like equipment handy to lift the pool body off of the flatbed. This requires coordination of efforts between the recipient, the pool manufacturer/deliverer, and the provider of the crane. This coordination fails a surprisingly large amount of the time, resulting in the flatbed bearing the pool body arriving with no way of safely unloading the pool body from the flatbed. Such miscommunications are very costly in terms of time, logistics, and opportunity.

Thus, there remains a need for a method and apparatus that would allow quick and easy unloading of the preformed fiberglass swimming pool body from a flatbed truck without the presence of a crane. The present novel technology addresses this need.

### SUMMARY

The present novel technology relates to a method and apparatus for unloading a preformed fiberglass swimming pool body from a flatbed or like truck without the need of a crane. One object of the present novel technology is to provide an improved fiberglass swimming pool delivery system. Related objects and advantages of the present novel technology will be apparent from the following description.

### BRIEF DESCRIPTION OF THE DRAWINGS

FIG. 1 is a partial perspective view of a first embodiment fiberglass pool delivery assembly of the present novel technology.

FIG. 2 is a rear elevation view of the pool delivery assembly of FIG. 1 with the pool body supported by a flatbed truck.

FIG. 3 is an enlarged partial rear elevation view of the pool delivery assembly of FIG. 1 with the pool body raised above the flatbed truck.

FIG. 4 is an enlarged partial rear elevation view of a portion of the pool delivery system of FIG. 3.

FIG. 5 is a top perspective view of the system of FIG. 1. FIG. 6 is a process diagram of the steps in deploying and using the pool delivery system of FIG. 1.

### DETAILED DESCRIPTION OF THE PREFERRED EMBODIMENT

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

Preformed fiberglass swimming pool bodies, while excellent for in ground installation as swimming pools, are inherently large, bulky and difficult to transport. Preformed fiberglass swimming pool bodies are typically transported by flatbed and at their destination are removed from the flatbed by crane. The crane typically connects to the preformed fiberglass swimming pool body at four preformed and reinforced lift points by which the pool body may be manipulated without experiencing undue stress and damage. However, in the absence of an available crane, unloading the fiberglass pool body from the flatbed is difficult.

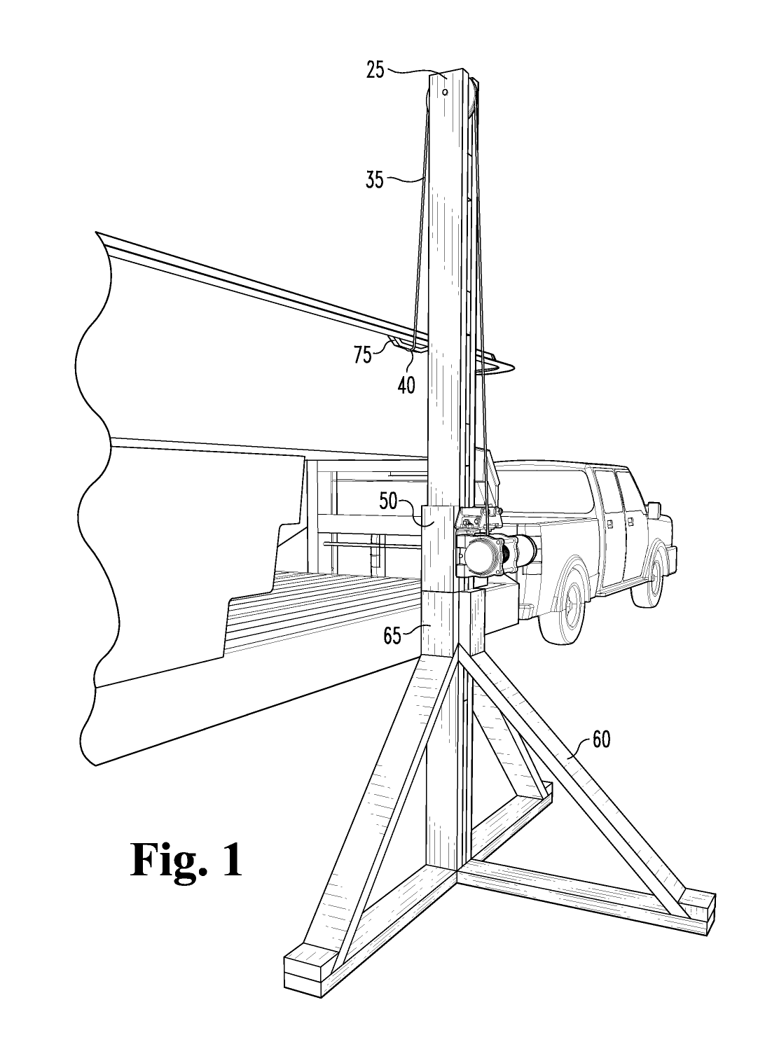

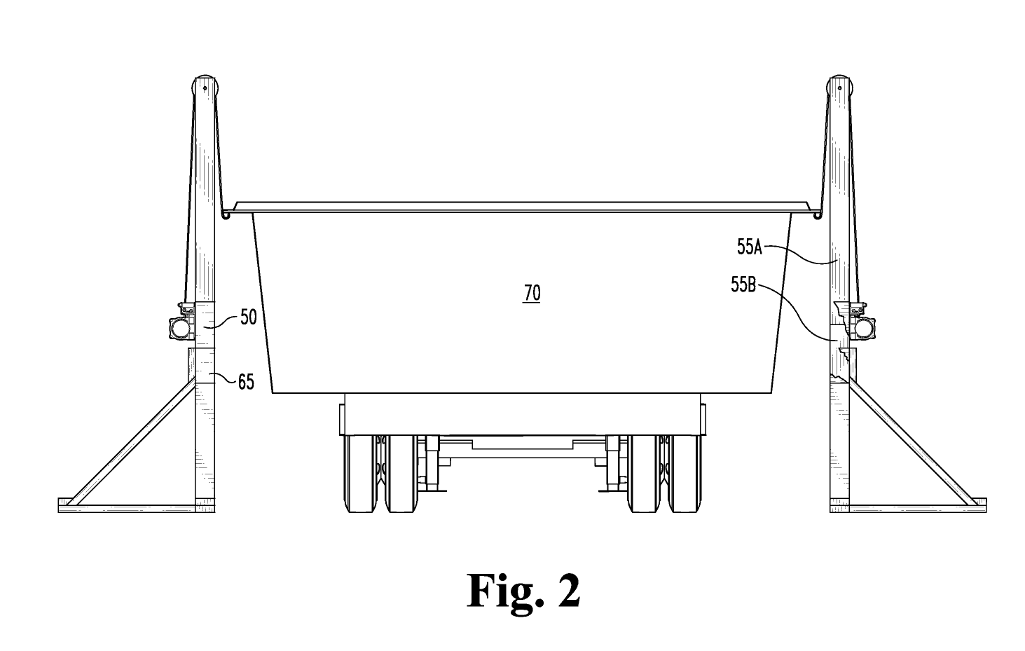

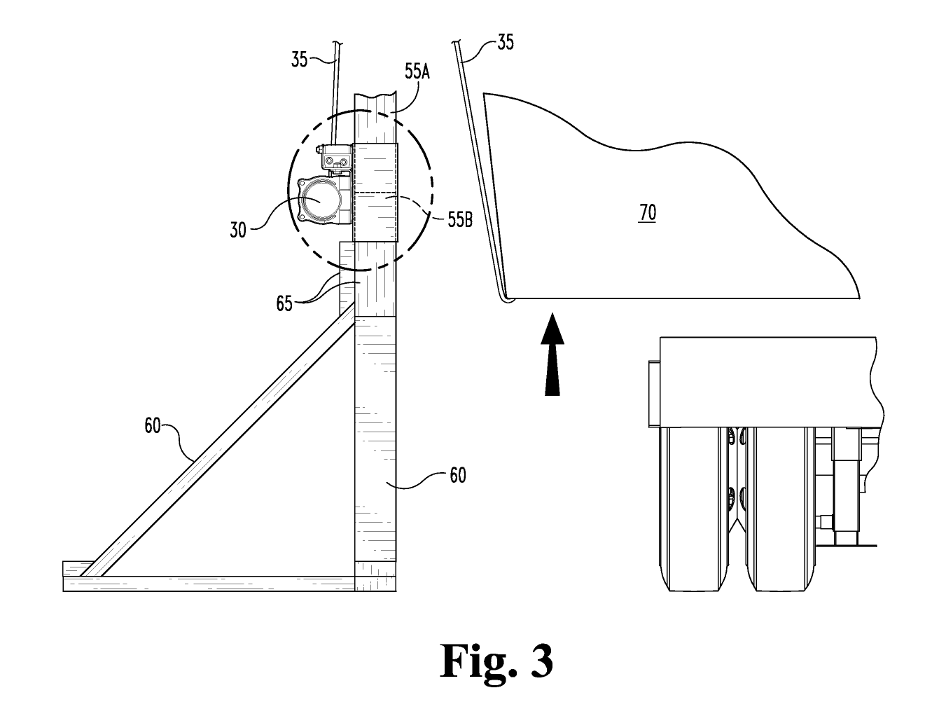

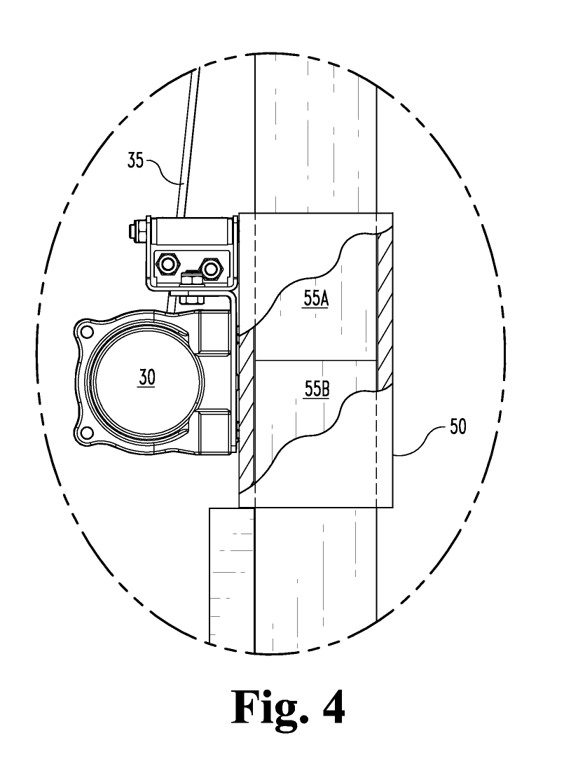

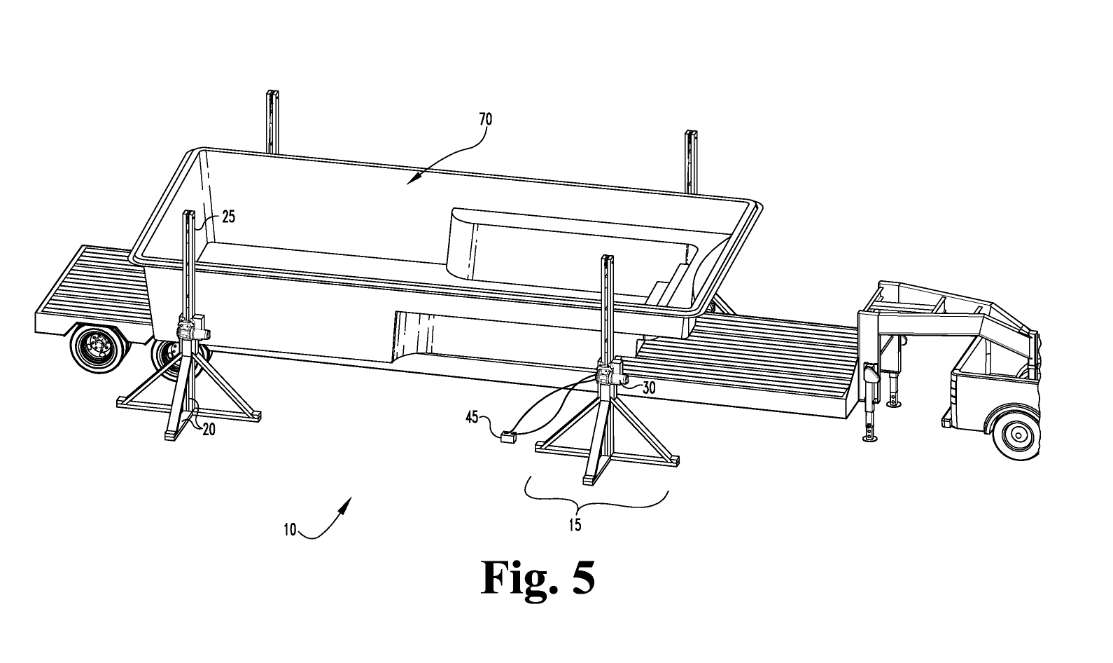

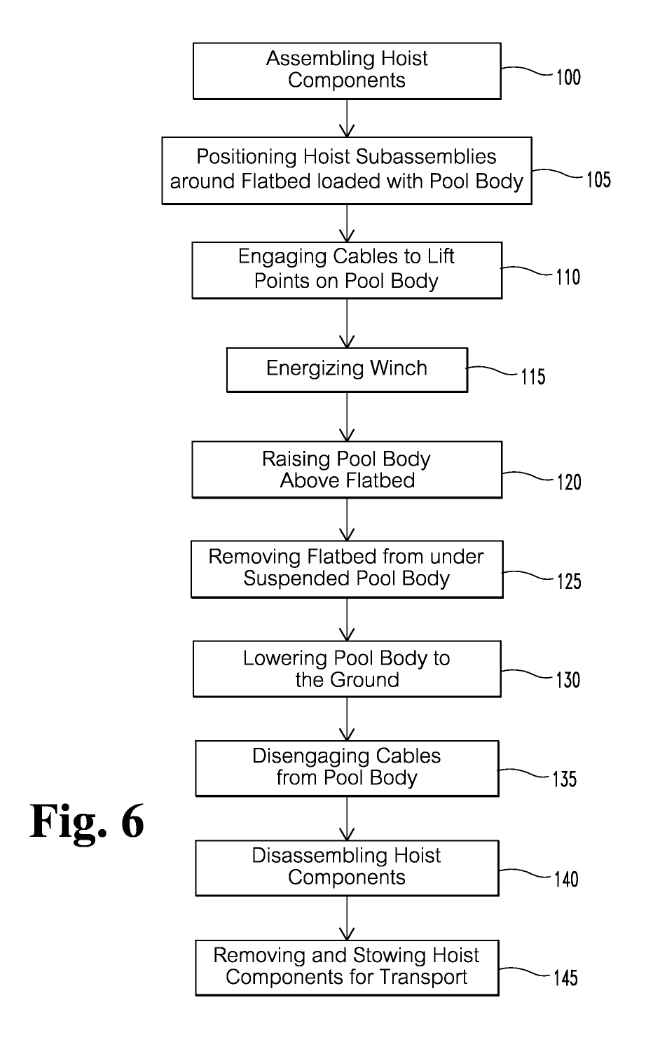

FIGS. 1-6 illustrate one embodiment of the present novel technology, a portable system 10 for raising a pool body off a flatbed to allow for removal of the flatbed and delivery of the pool body without a crane. The system 10 includes a plurality of portable hoist assemblies 15, each hoist assembly 15 having a base portion 20, an elongated structural member 25 connected to and extending from the base portion, an electric winch 30 connected to the base portion 20 or the elongated structural member 25, and a steel cable 35 operationally connected to the winch 30 and extending therefrom along the structural member 25. The cable 35 typically terminates in a hook, grapple, or like connecting member 40. A power source 45 is connectible to the winch 30 for energizing the winch 30 to extend and/or retract the cable 35.

The base portion 20 typically has a tripod or likewise mechanically stable configuration. A coupler 50 is operationally connected to the base portion 20 to engage the elongated structural member 25. In some embodiments, the base portion includes a plurality of legs 60 extendable from, and typically hingedly connected to, a connection portion 65, which may or may not be the coupler 50. In some embodiments, the coupler 50 slidingly engages the structural member 25 and can lock the structural member 25 to the base portion 20, such that the structural member 25 may be made to extend various distances from the base portion 20. In some embodiments, the structural member 25 contributes one leg 60 to the base portion 20 tripod. In some embodiments, the structural member 25 is hinged, while in other embodiments, the structural member 25 further comprises two discrete elongated member portions 55A, 55B that may be engaged to define the structural member 25.

The base portion 20, elongated structural member 25, and coupler 50 are typically made of structural materials, such as wood, aluminum, steel, or the like, but may be any convenient structural material. The cable 30 is typically steel, but may be any suitable material.

In operation, a number of hoist assemblies 15 are assembled 100 and positioned 105 around a preformed fiberglass swimming pool body 70 as delivered on a flatbed truck. Each respective hoist assembly 15 is typically positioned 100 adjacent a preformed lift point 75. The cable 35 and connector 40 are engaged 110 with the lift point 75. The winch 30 is energized 115, typically by electric connection to the power source 45; however, the winch may alternately be energized manually or by alternate means. The pool body 70 is then lifted a desired distance above the flatbed truck 120, and the truck is then removed 125 from beneath the suspended pool body 70. After the truck is removed 125, the pool body 70 is lowered 130 to the ground, the cables 35 are disengaged 135, the hoist assemblies 15 are partially or completely disassembled 140, and removed 145 for transport away from the site.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

1-13. (canceled)

14. A portable system for completing delivery of a preformed swimming pool body, comprising:
a plurality of hoist assemblies, each hoist assembly further comprising:
an elongated structural member;
a base portion;
a coupler connected to the base portion for receiving the elongated member;
a winch connected to the coupler;
a pulley operationally connected to the elongated structural member;
a cable operationally connected to the winch and extendable to engage the pulley; and
a grapple operationally connected to the cable;
wherein the plurality of hoist assemblies are deployable around a preformed swimming pool body;
wherein the deployed hoist assemblies are engageable to the swimming pool body; and
wherein the engaged hoist assemblies may be energized to raise and lower the swimming pool body.

15. The assembly of claim 14 wherein the elongated structural member is hinged.

16. The assembly of claim 14 wherein the elongated structural member further comprises a first elongated portion and a second elongated portion, and wherein the first and second elongated portions are joined in the coupler.

17. The assembly of claim 14 wherein the base portion further comprises a connection portion and three elongated legs extending from the connection portion.

18. The assembly of claim 14 and further comprising a power source operationally connected to the winch.

19. A kit for raising and lowering a fiberglass swimming pool body, comprising:
at least three elongated structural members, wherein each elongated member includes a pully operationally connected thereto;
at least three base portions;
at least three couplers, each respective coupler connectible to a respective base portion for receiving a respective elongated member;
at least three winches, each winch connectible to a respective coupler, wherein each winch includes a length of cable ending in a grapple operationally connected thereto.

20. A method of delivering a preformed swimming pool body with a flatbed truck, comprising:
a) removing hoist subassembly components from the flatbed truck, wherein hoist subassembly components further comprise:
four elongated structural members, wherein each elongated member includes a pully operationally connected thereto;
four base portions;
four couplers, each respective coupler connectible to a respective base portion for receiving a respective elongated member;
four winches, each winch connectible to a respective coupler, wherein each winch includes a length of cable ending in a grapple operationally connected thereto;
b) positioning the hoist subassemblies around the flatbed truck;
c) engaging cables to lift points on the pool body;
d) energizing respective winches;
e) raising the pool body above the flatbed;
f) removing the flatbed from beneath the pool body;
g) lowering the pool body to ground;
h) disengaging cables from the pool body;
i) disassembling the hoist subassemblies; and
j) stowing hoist components for transport.
